(19) United States
(12) Patent Application Publication
(10) Pub. No.: US 2024/0262266 A1
(43) Pub. Date: Aug. 8, 2024

(54) ARRANGEMENT AND METHOD FOR SUSPENDING A SEAT

(71) Applicant: Ullman Dynamics AB, VÄSTRA FRÖLUNDA (SE)

(72) Inventors: Carl Magnus Ullman, Västra Frölunda (SE); Johon Ullman, Västra Frölunda (SE)

(21) Appl. No.: 18/567,117

(22) PCT Filed: Jun. 10, 2022
(86) PCT No.: PCT/EP2022/065887

§ 371 Date: Dec. 5, 2023

(30) Foreign Application Priority Data
Jun. 10, 2021 (SE) 2150733-0

(51) Int. Cl. B60N 2/42; B60N 2/54

(52) U.S. Cl. CPC B60N 2/4235; B60N 2/54

(57) ABSTRACT

The disclosure relates to a seat arrangement comprising a seat. The seat is arranged to be suspended on a support structure by a first resilient member and a second resilient member attached to opposite longitudinal and/or lateral sides of the seat. The first and second resilient members are attached to the seat at a seat end of the first and second resilient members and to the support structure at a support structure end of the first and second resilient members respectively. When a load causes translational and/or rotational movement of the seat in a y-z plane of the seat, elastic shear deformation in the first and second resilient members controls the translational and/or rotational movement of the seat.

### TECHNICAL FIELD

The invention relates to a seat arrangement comprising a seat and a method for mitigating multi-axis impacts and movement.

### BACKGROUND ART

In the use of high-speed boats, impacts resulting from traversing waves can be severe due to the increased speed of the boat. Instead of following the contours of the waves, a high-speed boat can lose contact with the wave, resulting in high drops of up to several meters. This creates a need to protect drivers and occupants from not only purely vertical impacts, but also from lateral and oblique impact forces. Lateral forces are more dangerous for the human body than purely vertical. Severe impacts are rarely strictly vertical.

Most existing marine suspension seats have severe functional issues making them dangerous. Too forceful impacts can result in suspensions bottoming out. Bottoming out amplifies, instead of mitigating, the impacts on the occupant. Further, the lack of lateral shock mitigation capacity makes these seats unfit to protect users from the most dangerous impacts, namely those containing lateral forces. These functional issues increase the risk of severe injuries and overboard ejections which may lead to fatal accidents.

Both rigid seats and most suspension seats may have cushions that amplify rather than mitigate impacts transmitted from the boat to the seated person. Other issues that limit extensive use relate to the heavy weight and large space requirements for suspension mechanisms.

These issues can also arise in various situations on land, such as in vehicles travelling over uneven terrain, e.g. driving rally cars or off-road vehicles, and construction equipment borne by wheels or on continuous tracks.

Hence, there is a need for a seat suspension with minimum space requirements.

### SUMMARY OF THE INVENTION

An objective of the disclosure is to provide a seat arrangement comprising a seat and a method for mitigating multi-axis impacts and movement addressing the issues raised above. The objective is achieved by the seat arrangement of claim 1 and the method of claim 9. Dependent claims provide advantageous example embodiments.

The disclosure relates to a seat arrangement comprising a seat arranged to be suspended on a support structure by a first resilient member and a second resilient member. The first resilient member and the second resilient member are attached to opposite longitudinal and/or lateral sides of the seat. The first and second resilient members are attached to the seat, at a seat end of the first and second resilient members and to the support structure at a support structure end of the first and second resilient members respectively. When a load causes translational and/or rotational movement of the seat at least in a y-z plane of the seat (3), elastic shear deformation in the first and second resilient members (8, 9) controls the translational and/or rotational movement of the seat (3). A load can be a static load such as load from an occupant seated in the seat or a dynamic load, for instance due an occupant being subjected to an impact when travelling in rough seas while seated in the seat. With control is for instance meant control of direction of the seat as well as control of the amplitude of the seat along different axes.

The purpose of the seat arrangement according to the disclosure is to create an inexpensive seat suspension with minimum weight and space requirements that provides control over the seat's movement while providing a good dampening effect and reduction of peak acceleration of the seat's movement.

The basic principle of the seat arrangement is a suspension mechanism using resilient members to provide both a spring effect and a dampening effect. This dampening effect is achieved by designing resilient members and installing them in such a way that, when the seat is exposed to a load due to repeated impact forces, especially vertical and/or lateral impact forces resulting from translational and/or rotational movement of the seat in a y-z plane of the seat, the resilient members dampen the translational and/or rotational movement of the seat by shear deformation, rather than by e.g. compression or stretching. By suspending the seat of the seat arrangement as described herein, control of the translational and/or rotational movement of the seat when exerted to a load can be achieved.

Shear deformation (including torsion), instead of the other modes of deformation (i.e. compression, stretching, or bending), will result in that a significant part of the energy absorbed by the resilient member is converted to heat, and only a minor part of the absorbed energy will act in restoring the element to its original shape. This way, the resilient members themselves accomplish the shock absorption while still being able to return the seat to its initial state after each impact event. By this means of suspending the seat on a support structure, the seat is allowed to move in all degrees of freedom.

The resilient members may be one or more of wire-rope isolators or elastomeric elements. Some resilient members of the above types have the desired properties described above and are easy to install and maintain. Other types of resilient members that display the above characteristics are also conceivable.

The seat may comprise a seat pan and a seat arrangement member extending vertically above the surface of the seat pan, wherein the first resilient member is arranged to be attached to a front end of the seat and the second resilient member is arranged to be attached to the seat arrangement member at a rear end of the seat. In this way, seats normally used in boats can be easily adapted to be impact mitigating. The first resilient member can be arranged to be attached to a front end of the seat pan, and the second resilient member can be arranged to be attached to a rear end of the seat pan. Alternatively, the first resilient member can be arranged to be attached to a front end of the seat pan and the second resilient member is arranged to be attached to a rear end of the seat arrangement member.

The seat arrangement member may comprise a number of vertically spaced attachment points for the seat end of the second resilient member to be attached to, and the support structure comprises corresponding vertically spaced attachment points for the support structure end of the second resilient member to be attached to. In this way, the characteristics of the seat arrangement can be changed, for instance in relation to the length and/or weight of the person intended to use the seat arrangement, or to optimise the pattern of deflection of the seat relative to horizontal forces.

The second resilient member may be arranged on the seat at a height above the seat pan surface such that an imaginary line extends between the support structure end of the first resilient member and the support structure end of the second resilient member, essentially above an occupant's contact point of mass load on the seat. In this way, the weight of the occupant is loaded onto the seat pan and the part of the suspended seat where the occupant's point of mass load is situated beneath an imaginary line or axis extending between the forward resilient member and the rear resilient member. In this way, being exerted to a static force, such as during the heeling of a sailboat, a vertical axis of the seat will strive to align with the vertical axis of gravity, leading to that an occupant will be able to sit essentially horizontal in the seat. When an impact containing lateral forces accelerates the seat arrangement sideways, the resilient members will mitigate the impact, so that the resilient members will dampen the lateral movement of the seat arrangement. This is caused by that the entire seat will rotate around the imaginary line, leading to that an occupant's head will stay essentially in the same place during the impact, while the hips and lower back rotate with the seat. This leads to that the spine is essentially straight throughout the impact. This results in aligning the residual impact forces to affect the spine mainly along its anatomical axis and reduces the more dangerous lateral bending forces acting on the spine. The resilient members will also, by being skewed in the true direction of the impact, absorb energy, mitigate the impact, and strive to return the seat arrangement to its nominal position when resuming their original shapes. In this way, the seat's movement can be controlled.

The seat may comprise a seat pan and a seat arrangement member, wherein at least one resilient member is arranged to be attached to a first lateral side of the seat pan and at least one resilient member is arranged to be attached to a second lateral side of the seat pan. Alternatively or complementary, at least one resilient member is arranged to be attached to a first lateral side of the seat arrangement member and at least one resilient member is arranged to be attached to a second lateral side of the seat arrangement member. In this way, the seat is configured to mitigate lateral impacts or movements when there is no need or less need to mitigate vertical impacts or movements. This configuration can be used on trains where an occupant experiences movements substantially in the lateral direction only.

The first resilient member may have a first extension direction relative to one or more of the x-y plane, x-z plane and y-z plane of the seat and the second resilient members may have a second extension direction relative to one or more of the x-y plane, x-z plane and y-z plane of the seat, wherein the first and second extension directions are between 0° and 90°. Using resilient members that have an extension direction, i.e. are oriented in different ways relative the x-y plane of the seat, the movement of the seat during impacts can be fine-tuned to reduce the strain on different body parts.

The disclosure relates to a surface vehicle comprising a seat arrangement according to the disclosure, wherein the surface vehicle is a sailboat such as a sailing yacht, a motorboat such as a go-fast boat or a wheeled or tracked land vehicle.

The disclosure also relates to a rail vehicle comprising a seat arrangement according to the disclosure, wherein the rail vehicle is a passenger or cargo train.

The disclosure also relates to a method for mitigating multi-axis impacts and movement, wherein the method comprises:
providing a seat arrangement comprising a seat,
suspending the seat to a support structure by attaching a first resilient member and a second resilient member on opposite longitudinal and/or lateral sides of the seat,
   wherein the first and second resilient members are attached to the seat at a seat end of the first and second resilient members and to the support structure at a support structure end of the first and second resilient members respectively,
   wherein, when a load causes translational and/or rotational movement of the seat at least in a y-z plane of the seat, elastic shear deformation in the first and second resilient members controls the translational and/or rotational movement of the seat.

The method may also comprise:
providing a seat comprising a seat pan and a seat arrangement member extending vertically above the surface of the seat pan,
attaching the first resilient member to a front end of the seat, and
attaching the second resilient member to the seat arrangement member at a rear end of the seat.

The method may also comprise:
providing the seat arrangement member with a number of vertically spaced attachment points for the seat end of the second resilient member to be attached to,
providing the support structure with corresponding vertically spaced attachment points for the support structure end of the second resilient member to be attached to.

The method may also comprise:
arranging one resilient member on the seat arrangement member at a height H above the seat pan surface such that an imaginary line extending between the support structure end of the first resilient member and the support structure end of the second resilient member essentially extends above an occupant's contact point of mass load on the seat.

The method may also comprise:
providing a seat comprising a seat pan and a seat arrangement member,
attaching at least one resilient member to a first lateral side of the seat pan and attaching at least one resilient member to a second lateral side of the seat pan, and/or
attaching at least one resilient member to a first lateral side of the seat arrangement member and attaching at least one resilient member to a second lateral side of the seat arrangement member.

The method may also comprise:
arranging the first resilient member to have a first extension direction relative to one or more of the x-y plane, x-z plane and y-z plane of the seat and the second resilient members to have a second extension direction relative to one or more of the x-y plane, x-z plane and y-z plane of the seat, wherein the first and second extension directions of the respective first and second resilient member are between 0° and 90°.

The advantages for the method are the same as described above.

### BRIEF DESCRIPTION OF THE DRAWINGS

FIG. 1 schematically shows a vehicle comprising a seat arrangement according to the disclosure,

FIGS. 2a-2b schematically show a seat arrangement according to a first embodiment of the disclosure,

FIG. 3 schematically shows a wire rope isolator as an example of a resilient member,

FIG. 4 schematically shows a seat arrangement according to a second embodiment of the disclosure,

FIG. 5 schematically shows a seat arrangement according to a third embodiment of the disclosure,

FIG. 6 schematically shows a seat arrangement according to a third embodiment of the disclosure,

FIG. 7 schematically shows a seat arrangement according to a third embodiment of the disclosure,

FIGS. 8a-8b schematically shows a seat arrangement according to a fourth embodiment of the disclosure.

### DETAILED DESCRIPTION

Within the context of this application, a surface vehicle is a vehicle that can operate either on a land surface or a surface of a body of water, or both. Non-limiting examples of surface vehicles are sailboats such as a sailing yacht, motorboats such as a go-fast boat or a wheeled or tracked land vehicle such as sandrails, dune buggies or tanks. Hovercrafts is one non-limiting example of a surface vehicle that can operate on both a land surface and a surface of a body of water.

For a definition of a go-fast boat, see for instance https://en.wikipedia.org/wiki/Go-fast_boat or https://www.discoverboating.com/resources/go-fast-boats. These types of boats include rigid-hulled inflatable boat (RHIB) often used by law enforcement and military. The seat arrangement can also be used to good effect in surface vehicles that operate on land, especially where the there is a need to traverse uneven terrain and/or roads. The seat arrangement is suitable for both high-speed travel, such as in rally cars or off-road vehicles and for vehicles operating at lower speeds on uneven terrain, such as construction vehicles. The seat arrangement provides an improved comfort and reduction of impact stress on occupants for both wheeled and tracked vehicles.

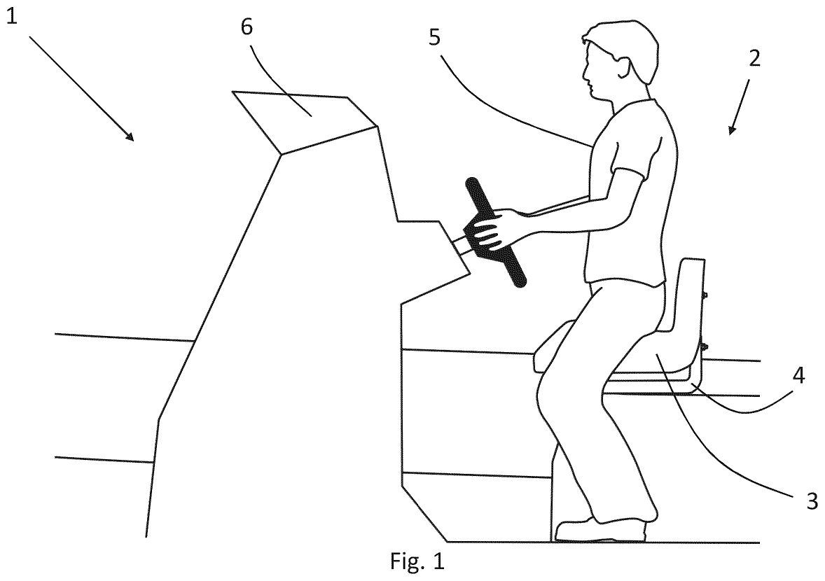

FIG. 1 schematically shows a vehicle 1 comprising a seat arrangement 2 according to the disclosure. The vehicle 1 could be any one of the vehicles listed above, for example a boat.

The seat arrangement 2 comprises a seat 3. The seat 3 is arranged to be attached to a support structure 4. An occupant 5, in this case a driver, is seated on the seat 3 in front of a control console 6. With support structure is meant for instance a rigid structure such as a frame or bracket that can be an integral part of the boat, that can be rigidly attached to the boat or that can be attached to a further suspension unit, which in turn is attached to the boat.

The seat arrangement 2 in this example and in the following example embodiments described is a so-called jockey seat, i.e. a seat with a saddle shaped seat pan that can be a standalone seat pan or have a seat back. The seat back can be connected to the seat pan or be separate from the seat pan. Examples of jockey seats can be found at https://ullmandynamics.com/suspension-seats/jockey-seats. Other seat types can also benefit from the disclosure such as bucket seats or bolster seats.

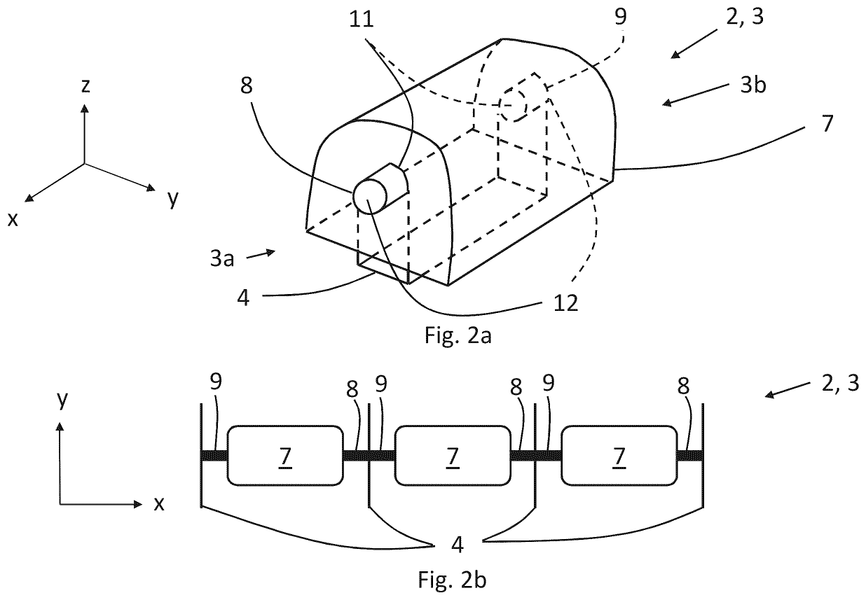

FIGS. 2a-2b schematically show a seat arrangement 2 according to a first embodiment of the disclosure. In the description, a coordinate system x, y, z (lowercase) where the where the x-axis is a longitudinal axis extending along the length of the seat 3, the y-axis is a transverse axis extending from side to side of the seat 3 and the z-axis is the vertical axis extending along the height of the seat 3. This coordinate system is used e.g. to describe the spatial relationship between various parts of the disclosure and the directions of forces.

The forces most dangerous to an occupant are those that result in a combined vertical and lateral movement. This movement can also be described as an oblique movement, i.e. a movement at an angle relative to one or more of an axis of the coordinate system x, y, z.

In the first embodiment of FIG. 2a, the seat arrangement 2 comprises a seat 3 comprising only a seat pan 7. The seat pan 7 is arranged to be attached to the support structure 4 by a first resilient member 8 and a second resilient member 9 arranged on opposite longitudinal sides of the seat pan 7, i.e. at a front end 3a and a rear end 3b of the seat 3. The first and second resilient members 8, 9 are attached to the seat 3 at a seat end 11 and to the support structure 4 at a support structure end 12 opposite the seat end 11, respectively. Arranging the first and second resilient members 8, 9 in this way primarily causes elastic shear deformation in the first and second resilient members 8, 9 upon the vertical and/or lateral movement of the seat 3 caused by the vehicle's motion rather than by compressing or stretching the first and second resilient members 8, 9. Elastic shear deformation results in that a significant part of the energy that is transferred to the resilient members 8, 9 from the movement of the seat 3 and thereby deforming the resilient members 8, 9 is converted to heat. That the deformation is elastic allows the seat to return to its initial state after each impact event. Only a minor part of the energy transferred to the resilient members 8, 9 from the movement of the seat 3 will act in restoring the element to its original shape. In this way, the resilient members 8, 9 themselves accomplish the shock absorption without further need for additional shock absorption. The resilient members can also be combined with other kinds of seat shock absorption to increase the shock absorbing effect.

In FIG. 2a, the first resilient member 8 and second resilient member 9 are arranged on opposite longitudinal sides of the seat pan 7 at a front end 3a and a rear end 3b of the seat 3. It is also possible for one or more of the front end and back end 3a, 3b of the seat 3 to extend beyond the opposite longitudinal sides (or lateral sides where applicable) where the first and second resilient members 8, 9 are arranged to be positioned. I.e., the opposite longitudinal and lateral sides where the first and second resilient members 8, 9 are arranged can be members attached to a seat structure that are placed underneath the front end and/or back end of the seat.

The first and second resilient members 8, 9 can be attached to the seat pan 7 and support structure by any means suitable, such as with screws, bolts or other threaded fasteners. Other type of fasteners that provide suitable fastening strength can also be possible. The resilient members 8, 9 are attached to the seat 3 and support structure 4 such that forces acting in the y-z-plane result in elastic shear deformation of the resilient members 8, 9.

FIG. 2b shows a row of seat arrangements 2 according to FIG. 2a as seen from above, e.g. along the vertical axis. This type of setup can be found in for instance rigid-hulled inflatable boats used by military, law enforcement or sightseeing excursions. Such a setup of seat arrangements 2 can also be beneficial in the other types of vehicles mentioned above where space constraints and ease of installation are valuable.

In the example of FIG. 2b, three seat arrangements 2 can be seen arranged longitudinally one after the other. Each seat arrangement 2 is arranged to be attached to the support structure 4 by a first resilient member 8 and a second resilient member 9 arranged on opposite longitudinal sides of the seat pan 7. In between the seat arrangements 2, a part of the support structure 4 can function as a divider between the seat arrangements 2 and can be used as for instance a handrail that occupants may use to support themselves in the seat 3 and/or be equipped with various details such as storage compartments or other utility details. The size of the resilient members 8, 9 in the figure are for illustrative purposes and can be smaller or larger depending on the desired characteristics.

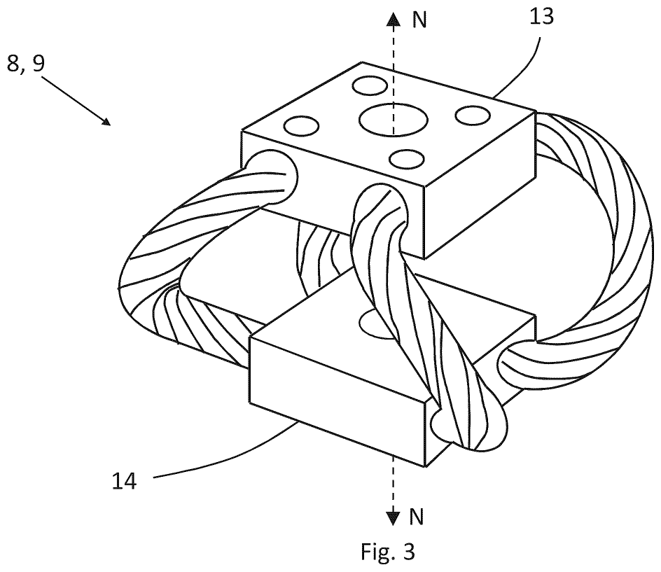

FIG. 3 schematically shows a wire rope isolator as an example of a resilient member 8, 9. A first example of a resilient member is a wire rope isolator with a first attachment part 13 that can be attached to the seat 3 and a second attachment part 14 that can be attached to the support structure 4. A wire rope isolator can for instance be made of stainless steel wires twisted into a cable, which is mounted between the first and second attachment parts 13, 14. Depending on the desired damping of the resilient element, the wire rope isolator can for instance be designed with more coils/loops of wire, thicker or narrower wire and larger first and second parts that allow for more coils or more separation between coils. Materials can be chosen to make the wire rope isolators resistant to e.g. salt water, oil or other chemicals that can be present in a vehicle. In the example of FIG. 3, the wire rope isolator is arranged to be attached by means of bolts or screws.

When attached to the seat 3, the first resilient members 8, 9 are arranged to have an extension direction relative to a y-z plane of the seat, or relative to the x-direction. The extension of the resilient members 8, 9 is defined to be along a normal line N to the respective attachment parts 13, 14 of each resilient member 8, 9. When the attachment parts 13, 14 are attached to the seat 3 and support structure 4 vertically, the normal N extends along the x-direction or the normal of the y-z plane if the resilient members 8, 9 are attached to a longitudinal side of the seat 3. The normal N extends along the y-direction or the normal of the x-z plane if the resilient members 8, 9 are attached to a lateral side of the seat 3. The normal N extends along the z-direction or the normal of the x-y plane if the resilient members 8, 9 are attached to a bottom or top side of the seat 3. By changing the extension direction of the attachment parts 13, 14 of the resilient members 8, 9 relative the normal of the y-z plane of the seat and thereby the extension direction of the entire resilient member 8, 9, the movement of the seat during impacts can be adapted to achieve a desired damping effect. Each resilient member 8, 9 can have a different extension direction relative the normal of the y-z plane of the seat.

The attachment parts 13, 14 of each resilient member 8, 9 are intended to be attached to the seat 3 and support structure 4 essentially opposite each other such that the resilient members 8, 9 are essentially unbiased when no load is exerted on the seat 3, i.e. there is little to none shear deformation on the resilient members 8, 9.

A second example of a resilient member (not shown) is a resilient member made from rubber or other natural or synthetic elastomers extending between the first and second attachment parts 13, 14, that, when exerted to shear deformation due to movement of the seat, absorb the kinetic energy transferred into them and convert the kinetic energy into heat. Depending on the desired damping of the resilient element, a resilient element made of rubber or other natural or synthetic elastomers can for instance be designed with different Shore hardness, cross sectional area, length of the member between seat end and support structure end, shape of the member in the length direction such as a straight shape, having a waist or a bulge shape, cross section shape of the member such as square or other quadrilateral shape, circular or oval.

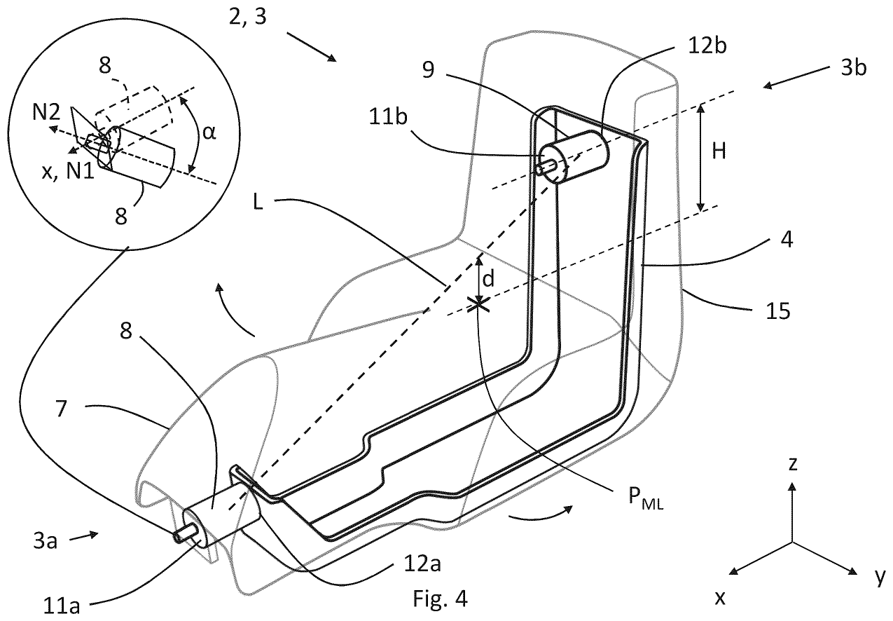

FIG. 4 schematically shows a seat arrangement 2 according to a second embodiment of the disclosure. The seat arrangement 2 according to the example embodiment of FIG. 4 is a jockey seat where the seat pan 7 and a seat arrangement member 15 extending vertically above the surface of the seat pan 7, in this example a seat back, are connected, making up one unitary seat 3. It is also possible for the seat pan 7 and seat arrangement member 15 to be separated, such that there is a gap between the seat pan 7 and the seat arrangement member 15. The seat arrangement member 15 can also function as a divider with handrails between seats arrangements 2 such as in the example of FIG. 2b. In this example, the seat arrangement member 15 is attached to the support structure 4 with the seat arrangement member 15 extending vertically above the surface of the seat pan 7 to be able to achieve vertical separation of the first and second resilient members 8, 9. The seat arrangement member 15 may thus have either padding or no padding depending on the desired setup.

The seat pan 7 and seat arrangement member 15, i.e. the seat back, are outlined so that the support structure 4 and resilient members 8, 9 can be seen properly. As can be seen in FIG. 4, the seat 3 is attached to the support structure 4 by a first resilient member 8 and a second resilient member 9 arranged on opposite longitudinal sides of the seat 3. The first resilient member 8 is attached to the seat 3 at a first seat end 11a and to the support structure 4 at a first support structure end 12a. The second resilient member 9 is attached to the seat 3 at a second seat end 11b and to the support structure 4 at a second support structure end 12b. The support structure 4 is in turn arranged to be attached to the vehicle by means known in the art or forms an integral part of the vehicle. The support structure 4 can also be attached to a further suspension unit attached to the vehicle.

Different from the example embodiment of FIG. 2a, the seat arrangement 2 according to FIG. 4 is attached to the support structure 4 by first and second resilient members 8, 9 at different heights along the vertical axis y. The first resilient member 8 is attached to the seat 3 and support structure 4 at a front end 3a of the seat 3, which is a point below an occupant's contact point of mass load P_{ML} on the seat 3, i.e. the point where the occupant would place his seat bones to support him on the seat 3, i.e. a point on a seat pan surface. The second resilient member 9 is attached to the seat 3 and support structure 4 at a height H above the seat pan surface such that an imaginary line L extending between the first resilient member 8 and the second resilient member 9 extends essentially above an occupant's 5 contact point of mass load P_{ML} on the seat 3, separating the imaginary line L a vertical distance d from the occupant's contact point of mass load P_{ML}. This will be further illustrated below.

The effect of having the first and second resilient members 8, 9 arranged according to the above placements allow for the seat arrangement 2 to mitigate the impact, so that the lateral movement of the seat pan 7 will be dampened, aligning residual impact forces to affect the spine mainly along its anatomical axis and reducing the more dangerous lateral skewing, and bending forces acting on the spine. This is caused by that the entire seat 3 will rotate around the imaginary line L, as indicated by the arrows, essentially in the y-z plane of the seat 3, leading to that an occupant's head will stay essentially in the same place during the impact, while the hips and lower back rotate with the seat 3. This leads to that the spine is essentially straight throughout the impact. The placement of the resilient members 8, 9 will also bias the seat 3 to return to an upright position when no lateral forces are acting on the seat 3. In this way, the movement of the seat is controlled.

As mentioned in the description of FIG. 3, one or both of the resilient members 8, 9 can be arranged to have extension directions relative the normal to the y-z plane of the seat 3. In FIG. 4, the resilient members 8, 9 have extension directions that are essentially parallel to the x-direction of the seat, i.e. essentially along the normal to the y-z plane. In one example, as shown in the inset of FIG. 4, the first resilient member 8 is arranged to have a first extension direction that is oriented at an angle α relative to the normal of the y-z plane or the x-direction of the seat 3 while the extension direction of the second resilient member 9 stays the same as previously. In the inset, the original position of the first resilient member 8 as shown in the main FIG. 4 is shown in dashed lines; the example position of the first resilient member 8 is shown in whole lines. In the inset, a first normal N1 when the first resilient member 8 is in its original position is shown to have the same extension direction as the x-axis. A second normal N2 for when the first resilient member 8 is in the example position is seen to be oriented at an angle α relative the x-direction (or the y-z plane).

The angle α can be between 0° (extension direction along the x-direction of the seat 3) and 90° (perpendicular to the x-direction of the seat 3). In the example shown in the main FIG. 4, the first resilient element 8 has an extension direction of essentially 0°, i.e. along the x-axis. In the example in the inset in FIG. 4, the first resilient element 8 has an extension direction or angle α of approximately 45°. Other examples of angles α are for instance approximately 30° and approximately 60°. When using an angled extension direction, angles α between 25° and 65° have been shown to provide a good degree of control of the movement of the seat 3, even though a sufficient degree of control of the movement of the seat 3 can be obtained also with greater or smaller angles.

It is of course possible to have the extension direction of any resilient member be oriented relative one or more of the three axes x, y, z or relative to the normal of one or more of the y-z plane, x-z plane and x-y plane in order to optimize the seat's movement when subjected to forces from various directions. The above discussion is also valid for extension directions relative the other planes of the seat.

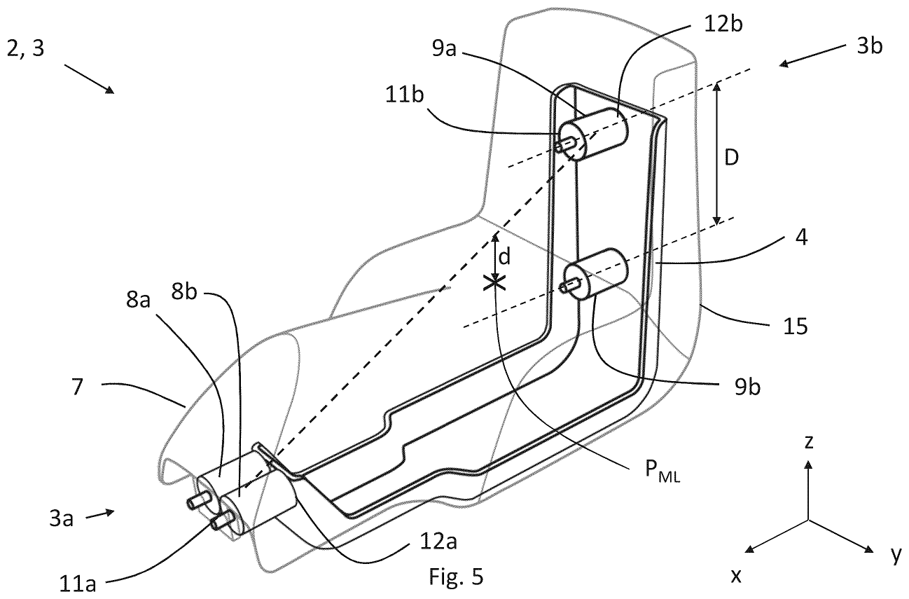

FIG. 5 schematically shows a seat arrangement 2 according to a third embodiment of the disclosure. To further increase the dampening effect, members that are more resilient can be placed at either the front end 3a or rear end 3b or at both the front and rear ends 3a, 3b of the seat 3. In the example of FIG. 5, two first resilient members 8a, 8b are placed side by side at the front end 3a of the seat 3 to increase the dampening effect at the front end 3a. This can be advantageous and provide more flexibility than placing one larger first resilient member 8 at the front end 3a of the seat 3. The two first resilient members 8a, 8b are in FIG. 5 placed abutting each other. It is also possible to have the two first resilient members 8a, 8b separated in the y-direction by a lateral distance to adapt the dampening of the seat 3 and the rotation resistance of the seat 3 to further control the movement of the seat.

Further, two second resilient members 9a, 9b are placed at a vertical distance D from each other at the rear end 3b of the seat 3. At least one of the second resilient members 9a, 9b is placed at a point above the occupant's contact point of mass load P_{ML} on the seat 3 such that the effect described in conjunction with FIG. 4 is achieved. The vertical distance D between the two second resilient members 9a, 9b can be adapted to specific impact behaviours. Separating the two second resilient members 9a, 9b will increase the mitigation of lateral forces at the rear end 3b of the seat 3 as well as the rotational resistance of the seat 3 around the imaginary line L. The two second resilient members 9a, 9b can have the same or different resilient properties such as e.g. the same or different shear modulus, different materials or different resilient members as described in conjunction with FIG. 3. Alternatively, or complementary, the two second resilient members 9a, 9b can be placed in a similar arrangement as the two first resilient members 8a, 8b, i.e. side by side, abutting or separated by a lateral distance and with or without one or more resilient members below the two second resilient members 9a, 9b at the vertical distance D.

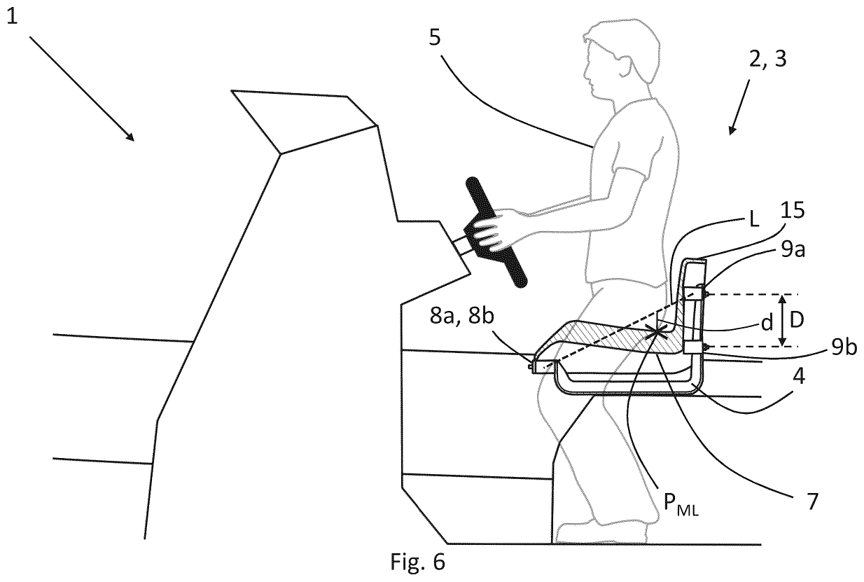

FIG. 6 schematically shows the seat arrangement 2 according to the embodiment of FIG. 5 from a side view. In FIG. 6, an occupant 5, in this case a driver is seated in the jockey seat. A contact point of mass load P_{ML} by the occupant 5 on the seat 3 is shown and as described above, is the point where the occupant's 5 weight is concentrated on the seat pan 7. An imaginary line can be seen extending between the first resilient members 8a, 8b and the upper of the two second resilient members 9a, 9b. As described above, the placement of the upper resilient member is such that the imaginary line L extends essentially above the point where the occupant's 5 weight is concentrated on the seat pan 7.

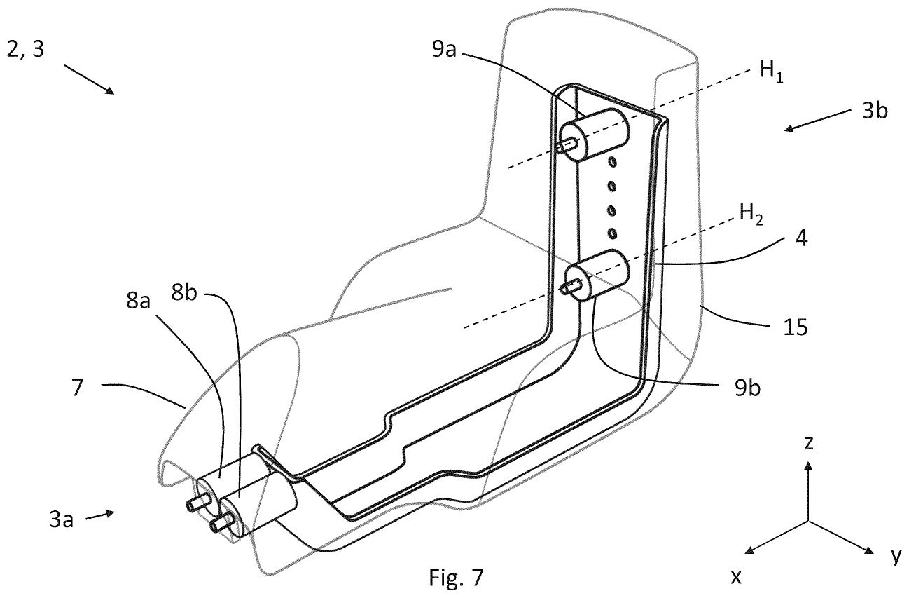

FIG. 7 schematically shows a seat arrangement 2 according to a third embodiment of the disclosure. The seat arrangement 2 of FIG. 6 is the same as the one described in FIG. 6 with the difference that a vertical height H₁ and H₂ of the first second resilient member 9a and second second resilient member 9b can be adapted by moving them between fixed locations in the support structure 4. Corresponding locations (not shown) are arranged in the seat arrangement member 15, in this embodiment the seat back. This allows for a more flexible adaptation of the seat arrangement's properties over the fixed placement of the second resilient members 9a, 9b of FIG. 6. It is also possible to have only one of the second resilient members 9a, 9b to be movable and to have one or more elongated openings in the support structure 4 to provide a flexible adaptation of the seat arrangement's properties.

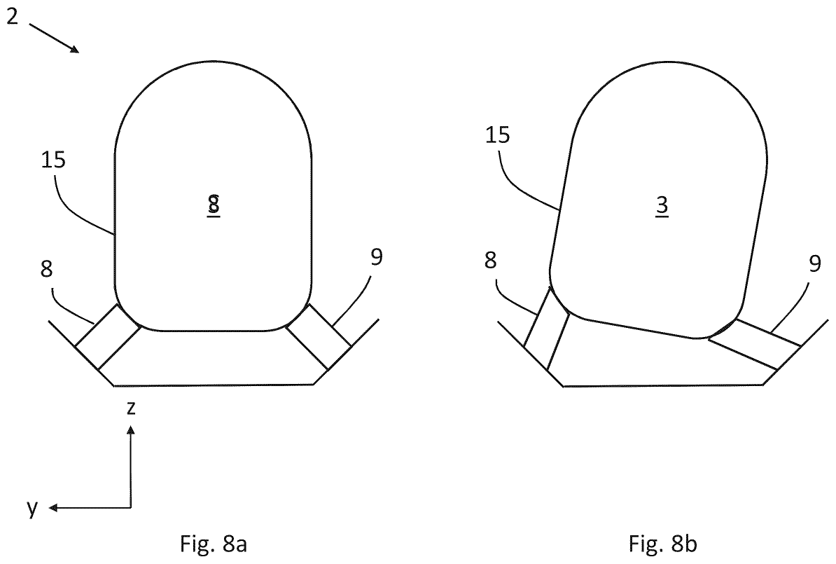

FIGS. 8a and 8b schematically show a seat arrangement 2 according to a fourth embodiment of the disclosure. In the embodiment of FIGS. 8a-8b, a seat 3 for a train is shown as a non-limiting example for this embodiment.

In FIG. 8a of the example embodiment, the seat 3 is not exposed to any lateral forces. The first resilient member 8 is arranged to be attached to a first lateral side of the seat arrangement member 15 and the second resilient member 9 is arranged to be attached to a second lateral side of the seat arrangement member 15. As an alternative, the first resilient member 8 is arranged to be attached to a first lateral side of the seat pan 7 (not shown) and the second resilient member 9 is arranged to be attached to a second lateral side of the seat pan 7. Alternatively, multiple resilient members can be arranged to be attached to both the seat pan 7 and the seat arrangement member 15 dependent on the design of the seat 3 and the desired characteristics of the resilient members 8, 9.

In FIG. 8b, a lateral force is exerted on the seat 3. As can be seen, the seat is arranged to rotate around a point below an upper part of the seat arrangement member 15, leading to the same effects as described above, i.e. that an occupant's head will stay essentially in the same place during the impact, while the hips and lower back rotates with the seat 3. This leads to that the spine is essentially straight throughout the impact. The placement of the resilient members 8, 9 will also bias the seat 3 to return to an upright position when no lateral forces are acting on the seat 3.

The seat arrangement 2 with the resilient members as described above are advantageous for absorbing forces comprising a lateral component and impacts occurring at high frequencies. An example of high frequency impacts with lateral components resulting from a smaller distance of travel is when a boat traverses choppy seas during maneuvering over many smaller waves where the distance of travel can be measured in the order of several centimetres to several decimetres. Today's vehicle seats are more suitable for absorbing essentially vertical forces resulting from impacts occurring at low frequencies and from a greater distance of travel of the vehicle. An example of a low frequency impact resulting from a greater distance of travel is when a boat traverses a wave crest and impacts the sea surface at the wave base or when a vehicle is travelling over sand and traverses a dune. When travelling in boats of the kinds described herein the distance of travel can be measured in the order of several decimetres to a few meters. A seat having a dampening system according to for instance https://ullmandynamics.com/information/why-choose-ullman-suspension-seats/suspension-boat-seats can preferably be combined with the seat arrangement 2 according to the disclosure.

Another application for the seat arrangement 2 according to the disclosure are seats for sailboats or so called helm seats. Even though the movement of these boats do not cause the same type of impacts as a high-speed powerboat as described above, a helm seat using resilient members according to the disclosure can be made to always be essentially horizontal during heeling of the boat. This leads to a better ergonomical position and increased comfort compared to today's seat where the helmsman sits inclined. This allows unloading of a significant part of the body weight from the legs to the seat and allows sitting comfortably on an essentially horizontal surface even when the boat is heeling.

By adapting shapes and sizes, as well as the positioning of the resilient members relative to the suspended parts of the seats, the movement of the seat 3 relative to the parts holding it in place can be optimized to achieve the optimal motion and stroke, thus optimizing the protection the seated person from multidirectional impact forces.

Reference signs mentioned in the claims should not be seen as limiting the extent of the matter protected by the claims, and their sole function is to make claims easier to understand.

As will be realised, the invention is capable of modification in various obvious respects, all without departing from the scope of the appended claims. Accordingly, the drawings and the description thereto are to be regarded as illustrative in nature, and not restrictive.

### REFERENCES

1. Vehicle
2. Seat arrangement
3. Seat
4. Support structure
5. Occupant
6. Control console
7. Seat pan
8. Front resilient member
   a. First front resilient member
   b. Second front resilient member
9. Rear resilient member
   a. First rear resilient member
   b. Second rear resilient member
10. Attachment points
11. Seat end of resilient member
   a. First seat end of resilient member
   b. Second seat end of resilient member
12. Support structure end of resilient member
   a. First support structure end of resilient member
   b. Second support structure end of resilient member
13. First attachment part of resilient member
14. Second attachment part of resilient member
15. Seat arrangement member
P_{ML}: Occupant's contact point of mass load
L: Imaginary line extending between front resilient member and rear resilient member
D: distance between first and second rear resilient member
d: distance between occupant's contact point of mass load and the imaginary line extending between front resilient member and rear resilient member
P_{ML}: Occupant's contact point of mass load

1. A seat arrangement comprising a seat (3), wherein the seat is arranged to be suspended on a support structure by a first resilient member and a second resilient member attached to opposite longitudinal and/or lateral sides of the seat, wherein the first and second resilient members are attached to the seat at a seat end of the first and second resilient members and to the support structure at a support structure end of the first and second resilient members respectively, wherein, when a load causes translational and/or rotational movement of the seat at least in a y-z plane of the seat, elastic shear deformation in the first and second resilient members controls the translational and/or rotational movement of the seat.

2. A seat arrangement according to claim 1, wherein the resilient members are one or more of wire-rope isolators or elastomeric elements.

3. A seat arrangement according to claim 1, wherein the seat comprises a seat pan and a seat arrangement member extending vertically above a surface of the seat pan, wherein the first resilient member is arranged to be attached to a front end of the seat and the second resilient member is arranged to be attached to the seat arrangement member at a rear end of the seat.

4. A seat arrangement according to claim 3, wherein the seat arrangement member comprises a number of vertically spaced attachment points for the seat end of the second resilient member to be attached to and the support structure comprises corresponding vertically spaced attachment points for the support structure end of the second resilient member to be attached to.

5. A seat arrangement according to claim 3, wherein the second resilient member is arranged on the seat at a height H above a seat pan surface such that an imaginary line extending between the support structure end of the first resilient member and the support structure end of the second resilient member extends essentially above an occupant's contact point of mass load (P_{ML}) on the seat.

6. A seat arrangement according to claim 1, wherein the seat comprises a seat pan and a seat arrangement member, wherein at least one resilient member is arranged to be attached to a first lateral side of the seat pan and at least one resilient member is arranged to be attached to a second lateral side of the seat pan and/or wherein at least one resilient member is arranged to be attached to a first lateral side of the seat arrangement member and at least one resilient member is arranged to be attached to a second lateral side of the seat arrangement member.

7. A seat arrangement according to claim 1, wherein the first resilient member has a first extension direction relative to one or more of an x-y plane, an x-z plane and the y-z plane of the seat and wherein the second resilient members has a second extension direction relative to one or more of the x-y plane, the x-z plane and the y-z plane of the seat, wherein the first and second extension directions are between 0° and 90° relative each of the x-y plane, the x-z plane and the y-z plane of the seat.

8. A seat arrangement according to claim 1, wherein the seat arrangement comprises two first resilient members, wherein the two first resilient members are abutting or are separated in a y-direction by a lateral distance.

9. A surface vehicle comprising a seat arrangement according to claim 1, wherein the surface vehicle is a sailboat such as a sailing yacht, a motorboat such as a go-fast boat or a wheeled or tracked land vehicle.

10. A rail vehicle comprising a seat arrangement according to claim 1, wherein the rail vehicle is a passenger or cargo train.

11. A method for mitigating multi-axis impacts and movement, wherein the method comprises:
providing a seat arrangement comprising a seat,
suspending the seat to a support structure by attaching a first resilient member and a second resilient member on opposite longitudinal and/or lateral sides of the seat, or wherein the first and second resilient members are attached to the seat at a seat end of the first and second resilient members and to the support structure at a support structure end of the first and second resilient members respectively, wherein, when a load causes translational and/or rotational movement of the seat at least in a y-z plane of the seat, elastic shear deformation in the first and second resilient members controls the translational and/or rotational movement of the seat.

12. A method according to claim 11, wherein the method comprises:
providing a seat comprising a seat pan and a seat arrangement member extending vertically above a surface of the seat pan,
attaching the first resilient member to a front end of the seat, and
attaching the second resilient member to the seat arrangement member at a rear end of the seat.

13. A method according to claim 12, wherein the method comprises:
providing the seat arrangement member with a number of vertically spaced attachment points for the seat end of the second resilient member to be attached to,
providing the support structure with corresponding vertically spaced attachment points for the support structure end of the second resilient member to be attached to.

14. A method according to claim 12, wherein the method comprises:
arranging one resilient member on the seat arrangement member at a height H above a seat-pan surface such that an imaginary line extends between a first support structure end of the first resilient member and the second support structure end of a second resilient member essentially above an occupant's contact point of mass load (P_{ML}) on the seat.

15. A method according to claim 11, wherein the method comprises:
providing a seat comprising a seat pan and a seat arrangement member,
attaching at least one resilient member to a first lateral side of the seat pan and attaching at least one resilient member to a second lateral side of the seat pan, and/or
attaching at least one resilient member to a first lateral side of the seat arrangement member and attaching at least one resilient member to a second lateral side of the seat arrangement member.

16. A method according to any one of claim 11, wherein the method comprises:
arranging the first resilient member to have a first extension direction relative to one or more of an x-y plane, an x-z plane and the y-z plane of the seat and the second resilient members to have a second extension direction relative to one or more of the x-y plane, the x-z plane and the y-z plane of the seat, wherein the first and second extension directions of the respective first and second resilient member are between 0° and 90°.

17. A method according to any one of claim 11, wherein the method comprises:
suspending the seat to the support structure by two first resilient members,
arranging the two first resilient members to abut, or
arranging the two first resilient members (8a, 8b) to be separated in a y-direction by a lateral distance.
